(19) United States
(12) Patent Application Publication
(10) Pub. No.: US 2023/0286121 A1
(43) Pub. Date: Sep. 14, 2023

(54) INSTALLATION TOOL

(71) Applicant: SHIFUKANG INDUSTRIAL.CO., LTD., Taichung City (TW)

(72) Inventor: SHANG-YUAN HUANG, Taichung City (TW)

(21) Appl. No.: 17/694,112

(22) Filed: Mar. 14, 2022

(51) Int. Cl. B25B 27/02

(52) U.S. Cl. CPC B25B 27/02

(57) ABSTRACT

An installation tool is provided, including: a main body, including a head portion, the head portion including a first blocking portion, a second blocking portion and a bottom portion, the first blocking portion and the second blocking portion being connected to and located at opposing sides of the bottom portion, the first blocking portion and the second blocking portion being separately arranged in a first direction, the first blocking portion and the second blocking portion having a height difference, the second blocking portion and the bottom portion defining a positioning portion, the positioning portion configured for engagement of a workpiece thereinto.

### BACKGROUND OF THE INVENTION

### Field of the Invention

The present invention relates to an installation tool.

### Description of the Prior Art

In many fields, a workpiece is usually to be engaged within positioning groove of a base (such as a rod, a shaft, etc.). The conventional installation tool for installing the workpiece has a groove, the groove is configured for engagement of the workpiece therewithin, so that the workpiece can be supported on the tool and can be pressed into the groove by the conventional installation tool.

However, in the conventional tool, opposing side walls defining the groove are of equal height so that the workpiece is supported at laterally corresponding points on the opposing side walls. When the workpiece is abutted against the base and the installation tool is pressed toward the base to press the workpiece, the workpiece can deviate easily and/or be bent and deformed by the reaction force of the base, which makes it difficult to press the workpiece into the groove and results in easy disengagement of the workpiece from the groove. It is not easy to install the workpiece and the workpiece is easy to deform and damage.

The present invention is, therefore, arisen to obviate or at least mitigate the above-mentioned disadvantages.

### SUMMARY OF THE INVENTION

The main object of the present invention is to provide an installation tool which can ease and stabilize installation of a workpiece.

To achieve the above and other objects, an installation tool, including: a main body, including a head portion, the head portion including a first blocking portion, a second blocking portion and a bottom portion, the first blocking portion and the second blocking portion being connected to and located at opposing sides of the bottom portion, the first blocking portion and the second blocking portion being separately arranged in a first direction, the first blocking portion and the second blocking portion having different height in a second direction lateral to the first direction, the first blocking portion, the second blocking portion and the bottom portion defining a positioning portion, the positioning portion being configured for engagement of a workpiece thereinto in the second direction, the first blocking portion including an abutting face facing the positioning portion and a first top end, the abutting face being lateral to the bottom portion and higher than the bottom portion in the first direction, the abutting face and the second blocking portion being configured for abutment of the workpiece thereagainst, the bottom portion having a bottom point, the second blocking portion including a second top end, the first top end and the second top end being both higher than the bottom point in the second direction, the first top end being farther from the bottom point than the second top end.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a cross-sectional view of a preferable embodiment of the present invention;

FIG. 4 is a partial enlargement of FIG. 3;

FIG. 5 is a front view of an operation member according to a preferable embodiment of the present invention;

FIG. 6 is a partial enlargement of FIG. 5;

FIG. 7 is a partial cross-sectional view, taken along a line A-A of FIG. 5, according to a preferable embodiment of the present invention;

FIG. 8 is a drawing showing application of a preferable embodiment of the present invention; and

FIG. 9 is a drawing showing another application of a preferable embodiment of the present invention.

### DETAILED DESCRIPTION OF THE PREFERRED EMBODIMENTS

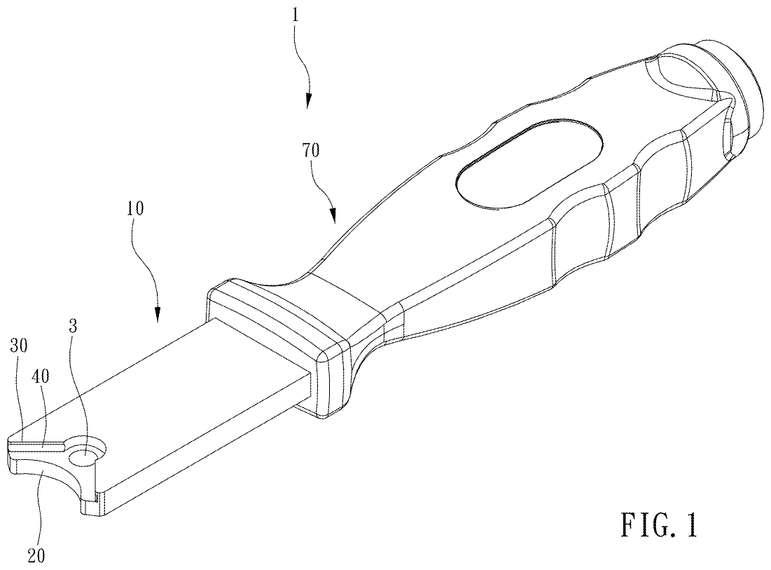

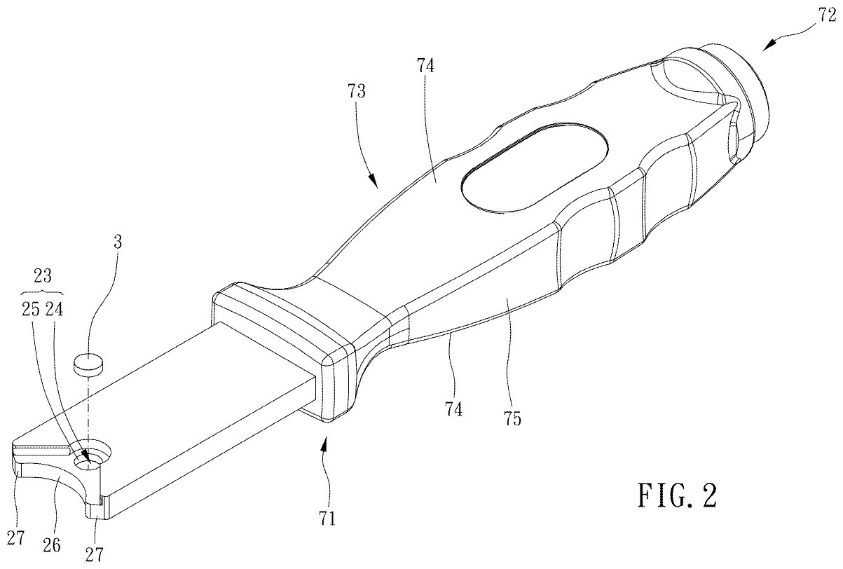

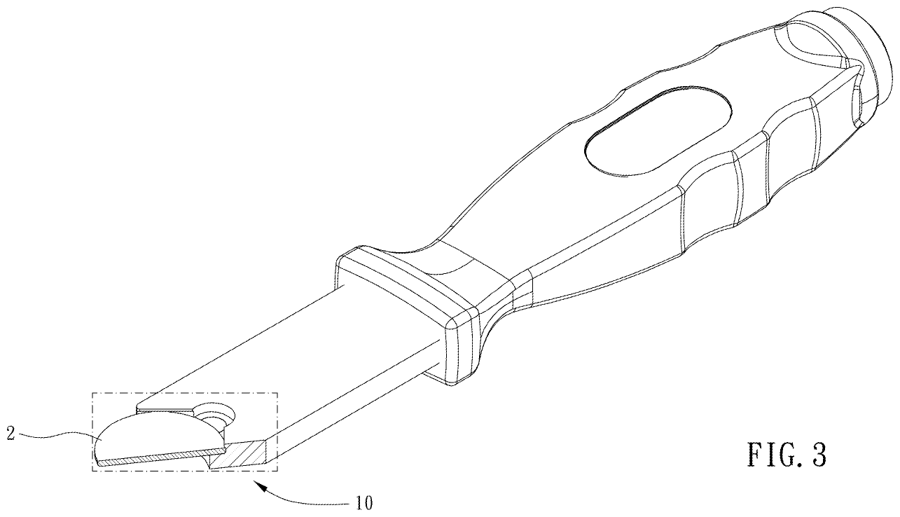

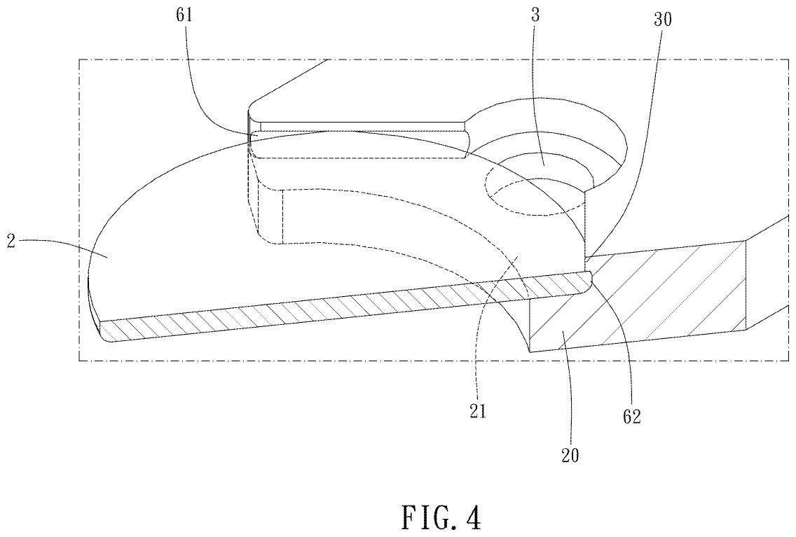

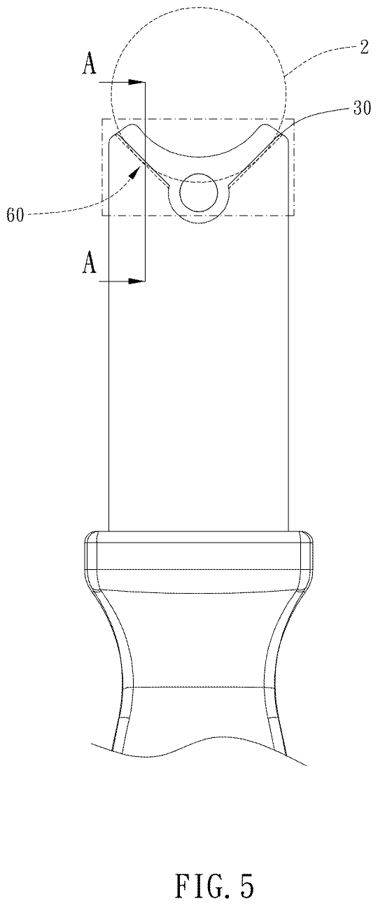

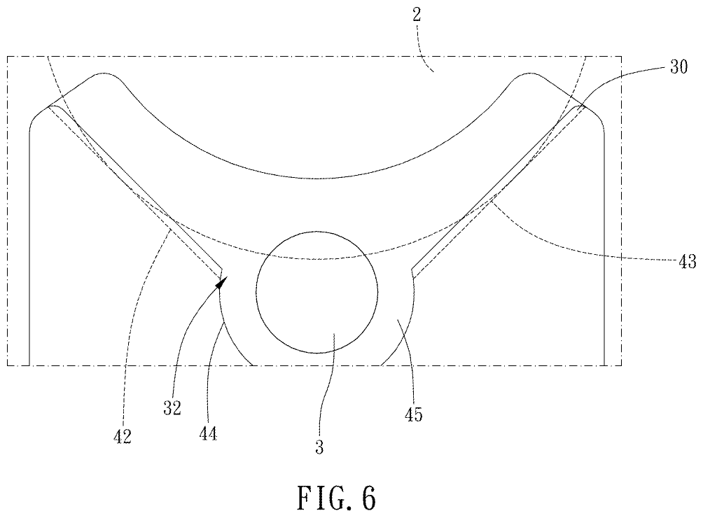

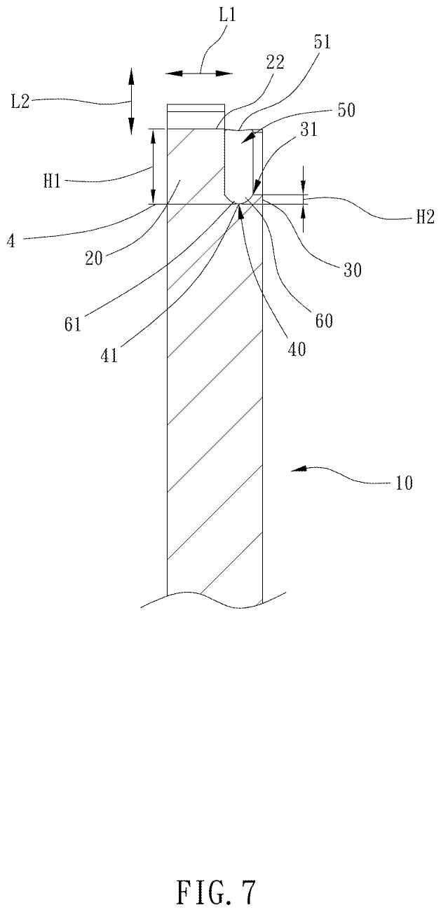

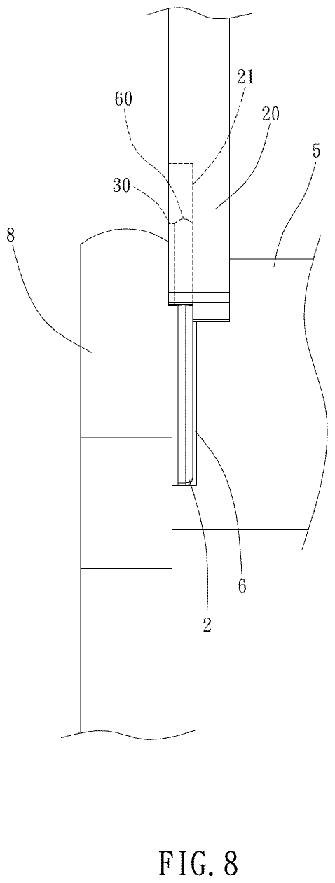

Please refer to FIGS. 1 to 9 for a preferable embodiment of the present invention. An installation tool 1 of the present invention includes a main body 1.

The main body 1 includes a head portion 10, and the head portion 10 includes a first blocking portion 20, a second blocking portion 30 and a bottom portion 40. The first blocking portion 20 and the second blocking portion 30 are connected to and located at opposing sides of the bottom portion 40, and the first blocking portion 20 and the second blocking portion 30 are separately arranged in a first direction L1. The first blocking portion 20 and the second blocking portion 30 have different height in a second direction L2 lateral to the first direction L1. The first blocking portion 20, the second blocking portion 30 and the bottom portion 40 define a positioning portion 50, and the positioning portion 50 is configured for engagement of a workpiece 2 thereinto in a second direction L2. The first blocking portion 20 includes an abutting face 21 facing the positioning portion 50 and a first top end 22, the abutting face 21 is lateral to the bottom portion 40 and higher than the bottom portion 40 in the first direction L1, and the abutting face 21 and the second blocking portion 30 are configured for abutment of the workpiece 2 thereagainst. The bottom portion 40 has a bottom point 41, the second blocking portion 30 includes a second top end 31, the first top end 22 and the second top end 31 are both higher than the bottom point 41 in the second direction L2, and the first top end 22 is farther from the bottom point 41 than the second top end 31. Preferably, the head portion 10 defines a reference line 4 parallel to the first direction L1 and passing through the bottom point 41, a distance from the first top end 22 to the reference line 4 is defined as a first height H1, a distance from the second top end 31 to the reference line 4 is defined as a second height H2, and the second height H2 is less than 0.5 times the first height H1. The workpiece 2 is protrusive beyond the first blocking portion 20 and the second blocking portion 30 in the second direction L2.

The workpiece 2 is configured to engage within the positioning portion 50, for buckling the workpiece 2 within a positioning groove 6 of a base 5. Specifically, when the workpiece 2 is engaged into the positioning groove 6 in the second direction L2, the workpiece 2 can be blocked by the first blocking portion 20 in the first direction L1 to abut against a side wall of the positioning groove 6, which easing and stabilizing the installation of the workpiece 2. The second blocking portion 30 can block the workpiece 2 from disengaging from the positioning portion 50 due to the applied force, so that as the installation tool is impacted (by a hammer, for example) in the second direction L2, the workpiece 2 can be stably engaged into the positioning groove 6. Since the first blocking portion 20 and the second blocking portion 30 have different height in the second direction L2, the first top end 22 and the second top end 31 can be abutted against different points of the workpiece 2 to stabilize and well support the workpiece 2, which prevents the workpiece 2 from deviation and deformation. At the beginning of overlapping of the first blocking portion 20 and the base 5 in the first direction L1, the second blocking portion 30 does not overlap with a seat 8 yet in the first direction L1 and is partially protrusive beyond the base 5 in the second direction L2 so that the workpiece 2 can be pressed into the positioning groove 6. In installation, the workpiece 2 can be abutted against the seat 8 in the second direction L2.

The second blocking portion 30 preferably includes a through hole 32 disposed therethrough in the first direction L1, thus reducing contact area with the seat 8 and easing withdrawal of the second blocking portion 30 located between the base 5 and the seat 8.

The positioning portion 50 includes a concave portion 60 recessed in the second direction L2, and the concave portion 60 is configured for engagement of the workpiece 2 thereinto in the second direction L2. The concave portion 60 includes an arcuate groove 61 and an arcuate surface 62 defining the arcuate groove 61, and the arcuate surface 62 is configured for abutment of the workpiece 2 thereagainst, As a result, it can be suitable to be applied to any of various workpieces of different thicknesses, it can block the bottom end portion of the workpiece 2 from displacing relative to the arcuate surface 62, and it can avoid deformation or warping of the workpiece 2.

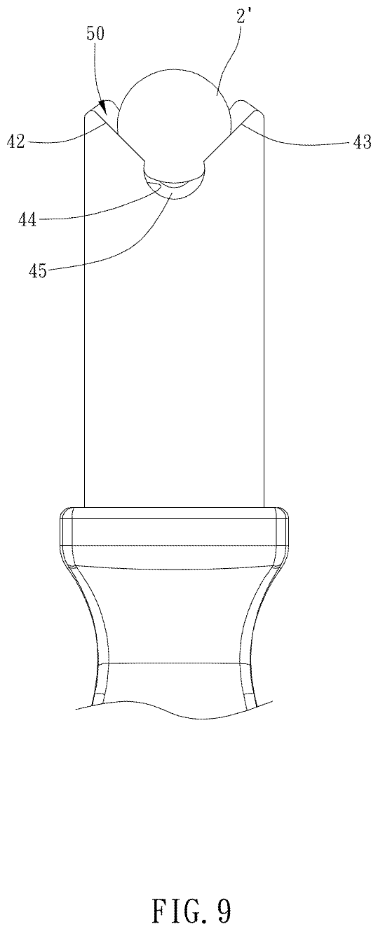

The bottom portion 40 includes a first abutting section 42, a second abutting section 43 and a concave section 44 which is concave in the second direction L2, the first abutting section 42 and the second abutting section 43 are connected to and located at opposing sides of the concave section 44, and the first abutting section 42 and the second abutting section 43 are configured for abutment of the workpiece 2 thereagainst. In this embodiment, the concave section 44 includes a lower recession 45, and the lower recession 45 is arcuate. Preferably, the positioning portion 50 includes an opening 51 which is open toward the second direction L2, and the first abutting section 42 and the second abutting section 43 extend obliquely and divergently from the concave section 44 in a direction away from the concave section 44. The lower recession 45 is configured for engagement of the workpiece 2′ therewithin (as shown in FIG. 9) so that it can be applied to any of various workpieces of different diametric dimensions and/or types.

The installation tool further includes a magnetically attractable member 3, and the magnetically attractable member 3 is disposed on the main body 1 and corresponds to the positioning portion 50 and is configured to magnetically attract with the workpiece 2. Preferably, the first blocking portion 20 includes a receiving portion 23, the receiving portion 23 includes a receiving space 24 and a circumferential wall 25 defining the receiving space 24, the circumferential wall 25 is circumferentially enclosed, and the magnetically attractable member 3 is disposed within the receiving space 24 so that the magnetically attractable member 3 is protected. In this embodiment, the lower recession 45 is open toward the first direction L1, and the magnetically attractable member 3 at least partially corresponds to the lower recession 45; the receiving space 24 is open toward the first direction L1 so that the workpiece 2 can be attracted by the magnetically attractable member 3 to engage within the positioning portion 50 in the first direction L1.

The first top end 22 includes a recess 26 which is recessed in the second direction L2 and two projections 27 which are located at opposing sides of the recess 26, and the magnetically attractable member 3 and the recess 26 are separately arranged in the second direction L2. The two projections 27 are configured to force two distal ends of the workpiece 2 to disengage the workpiece 2 from the positioning groove 6, and the magnetically attractable member 3 is not impacted in the second direction L2 so that the damage to the magnetically attractable member 3 due to external impact can be prevented.

The main body 1 further includes a handle portion 70, and the handle portion 70 includes a connection end portion 71, an impact end portion 72 and a grip section 73 connected with and between the connection end portion 71 and the impact end portion 72. The grip section 73 is flat, the grip section 73 includes two planes 74 opposite to each other and two connecting sides 75 opposite to each other, and each of the two connecting sides 75 is connected with and between the two planes 74. The impact end portion 72 is preferably made of metal, which provides good structural strength and good resistance to deformation.

With height difference between the first blocking portion and the second blocking portion, the workpiece can be well supported laterally at different points on opposing sides thereof, thus easing and stabilizing installation of the workpiece into the positioning groove.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An installation tool, including:
a main body, including a head portion, the head portion including a first blocking portion, a second blocking portion and a bottom portion, the first blocking portion and the second blocking portion being connected to and located at opposing sides of the bottom portion, the first blocking portion and the second blocking portion being separately arranged in a first direction, the first blocking portion and the second blocking portion having different height in a second direction lateral to the first direction, the first blocking portion, the second blocking portion and the bottom portion defining a positioning portion, the positioning portion being configured for engagement of a workpiece thereinto in the second direction, the first blocking portion including an abutting face facing the positioning portion and a first top end, the abutting face being lateral to the bottom portion and higher than the bottom portion in the first direction, the abutting face and the second blocking portion being configured for abutment of the workpiece thereagainst, the bottom portion having a bottom point, the second blocking portion including a second top end, the first top end and the second top end being both higher than the bottom point in the second direction, the first top end being farther from the bottom point than the second top end.

2. The installation tool of claim 1, wherein the positioning portion includes a concave portion recessed in the second direction, and the concave portion is configured for engagement of the workpiece thereinto in the second direction.

3. The installation tool of claim 2, wherein the concave portion includes an arcuate groove and an arcuate surface defining the arcuate groove, and the arcuate surface is configured for abutment of the workpiece thereagainst.

4. The installation tool of claim 1, wherein the bottom portion includes a first abutting section, a second abutting section and a concave section which is concave in the second direction, the first abutting section and the second abutting section are connected to and located at opposing sides of the concave section, and the first abutting section and the second abutting section are configured for abutment of the workpiece thereagainst.

5. The installation tool of claim 4, wherein the positioning portion includes an opening which is open toward the second direction, the first abutting section and the second abutting section extend obliquely and divergently from the concave section in a direction away from the concave section, and the concave section includes a lower recession.

6. The installation tool of claim 1, wherein the main body further includes a handle portion, the handle portion includes a connection end portion, an impact end portion and a grip section connected with and between the connection end portion and the impact end portion, the grip section is flat, the grip section includes two planes opposite to each other and two connecting sides opposite to each other, and each of the two connecting sides is connected with and between the two planes.

7. The installation tool of claim 1, further including a magnetically attractable member, wherein the magnetically attractable member is disposed on the main body and corresponds to the positioning portion and is configured to magnetically attract with the workpiece.

8. The installation tool of claim 7, wherein the first blocking portion includes a receiving portion, the receiving portion includes a receiving space and a circumferential wall defining the receiving space, the circumferential wall is circumferentially enclosed, and the magnetically attractable member is disposed within the receiving space.

9. The installation tool of claim 7, wherein the first top end includes a recess which is recessed in the second direction and two projections which are located at opposing sides of the recess, and the magnetically attractable member and the recess are separately arranged in the second direction.

10. The installation tool of claim 5, wherein the head portion defines a reference line parallel to the first direction and passing through the bottom point, a distance from the first top end to the reference line is defined as a first height, a distance from the second top end to the reference line is defined as a second height, and the second height is less than 0.5 times the first height; the positioning portion includes a concave portion recessed in the second direction, and the concave portion is configured for engagement of the workpiece thereinto in the second direction; the concave portion includes an arcuate groove and an arcuate surface defining the arcuate groove, and the arcuate surface is configured for abutment of the workpiece thereagainst; the lower recession is open toward the first direction, and the magnetically attractable member at least partially corresponds to the lower recession; the lower recession is arcuate; the installation tool further includes a magnetically attractable member, the magnetically attractable member is disposed on the main body and corresponds to the positioning portion and is configured to magnetically attract with the workpiece; the first blocking portion includes a receiving portion, the receiving portion includes a receiving space and a circumferential wall defining the receiving space, the circumferential wall is circumferentially enclosed, and the magnetically attractable member is disposed within the receiving space; the first top end includes a recess which is recessed in the second direction and two projections which are located at opposing sides of the recess, and the magnetically attractable member and the recess are separately arranged in the second direction; the workpiece is protrusive beyond the first blocking portion and the second blocking portion in the second direction; the main body further includes a handle portion, the handle portion includes a connection end portion, an impact end portion and a grip section connected with and between the connection end portion and the impact end portion, the grip section is flat, the grip section includes two planes opposite to each other and two connecting sides opposite to each other, and each of the two connecting sides is connected with and between the two planes; the impact end portion is made of metal.
